(19) United States
(12) Patent Application Publication
(10) Pub. No.: US 2014/0353365 A1
(43) Pub. Date: Dec. 4, 2014

(54) PACKING UNIT

(71) Applicant: Masanobu NOGI, Tokyo (JP)

(72) Inventor: Masanobu NOGI, Tokyo (JP)

(73) Assignee: RICOH COMPANY, LTD., Tokyo (JP)

(21) Appl. No.: 14/265,754

(22) Filed: Apr. 30, 2014

(30) Foreign Application Priority Data
May 29, 2013 (JP) 2013-112592

(51) Int. Cl. B65D 5/32; B31B 15/00

(52) U.S. Cl. CPC B65D 5/32; B31B 15/00
USPC 229/122.21; 493/102

(57) ABSTRACT

A packing unit includes an inner case made of cardboard to contain a good on an upper side, including a base panel having two pairs of opposing sides and two side panels to be folded up along one of the two pairs of opposing sides, and an outer case made of cardboard with a lid to be placed over the inner case, including a top panel to cover above the good and four side panels to cover side faces of the inner case. The cardboard of the side panels of the inner case includes an inner sheet with a flute having a long side in a vertical direction relative to a plane on which the packing unit is placed. The cardboard of the side panels of the outer case includes an inner sheet with a flute having a long side in a horizontal direction relative to the plane.

### CROSS REFERENCE TO RELATED APPLICATION

The present application is based on and claims priority from Japanese Patent Application No. 2013-112592, filed on May 29, 2013, the disclosure of which is hereby incorporated by reference in its entirety.

### BACKGROUND OF THE INVENTION

1. Field of the Invention

The present invention relates to a packing unit made of cardboard to pack goods including an office appliance such as printer, MFP (multifunction peripheral), or an electric appliance such as refrigerator, washing machine.

2. Description of the Related Art

A typical packing unit is described referring to FIGS. 11A, 11B. FIG. 11A is an exploded perspective view of a conventional packing unit 120. The packing unit 120 comprises a rectangular base 121 which is two panels coupled with an adhesive tape 135, four side panels 122 to 125 to stand on the four sides of the base 121, and four top flaps 126 to 129 connected with the four side panels 122 to 125. The packing unit 120 is a single cardboard sheet with slots and assembled by folding the panels along scores and joining them to form a cube. One handhold opening 130 is formed in the side panel 123 and the other one is formed in the side panel 122.

To pack a product 111 in the packing unit 120, lower spacers 131, 132, the product 111, and upper spacers 133, 134 are placed on the base 121 in this order, and the top flaps 126 to 129 are folded and secured them with an adhesive tape.

FIG. 11B shows another packing unit 160 comprising a bottom case 140 and a top case 150. The bottom case 140 includes a rectangular base 141 and side panels 142 to 145 to fold up from the four sides of the base 141. The bottom case 140 is a single cardboard sheet with slots and assembled by folding the panels along scores. The top case 150 is of a square shape with a lid having four side panels 151 to 154 and top flaps 155, 156. Likewise, the top case 150 is a single cardboard sheet with slots and assembled by folding the panels along scores.

For packing in the packing unit 160, lower spacers 131, 132, the product 111, and upper spacers 133, 134 are placed on the base 141 in this order and the top case 150 covers the upper spacers. Then, the top and bottom cases 150, 140 are joined via a not-shown connector. The connector inserts through a bottom hole 142a, a top hole 151a, a bottom through hole 143a and a not-shown top through hole of the side panel 152 to join the bottom case 140 and the top case 150.

Further, Japanese Patent Application Publication No. 08-048324 discloses a packing unit formed by folding up square panels of an inner box vertically and joining them with an adhesive. The packing unit comprises a box and a lid with flaps all round. With the lid on the box, one of the flaps corresponding to a side panel with an opening is formed to cover the entire surface of this side panel and another flap is formed to cover only a part of another side panel. The lid flaps include reinforced flaps on the side edges to extend all along the height of the box.

The packing unit 120 in FIG. 11A has resistance to a load from above and can be kept in stack in a storage or warehouse. It can be manufactured at a reduced cost. However, it has a drawback that when unpacking, the product 111 has to be raised above the height of the packing unit 120, which is troublesome for an operator.

In the packing unit 160 in FIG. 11B the product 111 can be easily taken out by detaching the top case 150 from the bottom case 140. However, the packing unit 160 requires a larger amount of costs since it comprises two elements of the top and bottom cases and it is susceptible to a load from above when piled up.

Further, the packing unit in the above patent document needs an additional work and device for applying an adhesive when packing a product as well as for assembling the packing unit by joining the outer box and inner box. This increases the manufacturing costs and price of the packing unit.

In storing or transporting, stacked packing units may be wrapped around with a stretch film for the purpose of preventing a collapse. FIG. 12 is a perspective view of stacked packing units wrapped around with a stretch film on a pallet. In the drawing packing units 120 containing products 111 are stacked in four tiers on a pallet 180 and an area 172 including the second and third tiers are wrapped around with a stretch film 171. A stretch film roll 170 is also shown.

The packing unit 120 is placed so that the long sides of flutes of the side panels 122 to 125 (FIG. 11A) are positioned along a vertical line, in order to exert a high rigidity against a load. The flutes are aligned in horizontal direction. In FIG. 12 a flute direction is indicated on a topmost packing unit on the left side. The corner of the packing unit indicated by vertical ridge lines may be buckled or deformed by a horizontal contraction of the stretch film since it cannot sufficiently bear horizontal compression. A deformed packing unit may cause the product 111 inside to be determined as defective even if it is free of anomaly.

### SUMMARY OF THE INVENTION

According to one embodiment, a packing unit comprises an inner case made of cardboard to contain a good on an upper side, including a base panel having two pairs of opposing sides and two side panels to be folded up along a first one of the two pairs of opposing sides as scores, and an outer case made of cardboard in a square shape with a lid to be placed over the inner case, including a top panel to cover above the good and four side panels to cover side faces of the inner case, wherein the cardboard of the side panels of the inner case includes an inner sheet with a flute having a long side in a vertical direction relative to a plane on which the packing unit is placed, and the cardboard of the side panels of the outer case includes an inner sheet with a flute having a long side in a horizontal direction relative to the plane on which the packing unit is placed.

### BRIEF DESCRIPTION OF THE DRAWINGS

Features, embodiments, and advantages of the present invention will become apparent from the following detailed description with reference to the accompanying drawings:

FIG. 1 is an exploded perspective view of a packing unit according to a first embodiment;

FIG. 2 is an exploded perspective view of the packing unit in FIG. 1 for packing a product;

FIGS. 3A, 3B are development views of an outer case and an inner case of the packing unit, respectively;

FIG. 4 is a perspective view of the packing unit when assembled;

FIG. 5 is a perspective view of the inner case of the packing unit;

FIG. 6A is a perspective view of the entire inner case with an enlarged view of a part thereof showing a protrusion to fit into a slit and FIG. 6B is a cross section view of a part thereof along the A to A line in FIG. 6A;

FIG. 7A is a perspective view of the entire inner case with an enlarged view of a handhold opening and FIG. 7B is a cross section view of a part thereof along the B to B line in FIG. 7A;

FIG. 8 is a partially cutout perspective view of the packing unit with an enlarged view of a part thereof showing the heights of the inner and outer cases;

FIG. 9 shows the packing unit in a fallen state;

FIG. 10A is a perspective view of an inner case of a packing unit according to a second embodiment and FIG. 10B is a development view of the same;

FIGS. 11A, 11B are exploded perspective views of a related art packing unit; and

FIG. 12 is a perspective view of related art packing units in stack on a pallet wrapped around a wrap film for prevention of load shifting.

### DETAILED DESCRIPTION OF PREFERRED EMBODIMENT

Hereinafter, embodiments of a packing unit will be described in detail with reference to the accompanying drawings. Wherever possible, the same reference numbers will be used throughout the drawings to refer to the same or like parts.

### First Embodiment

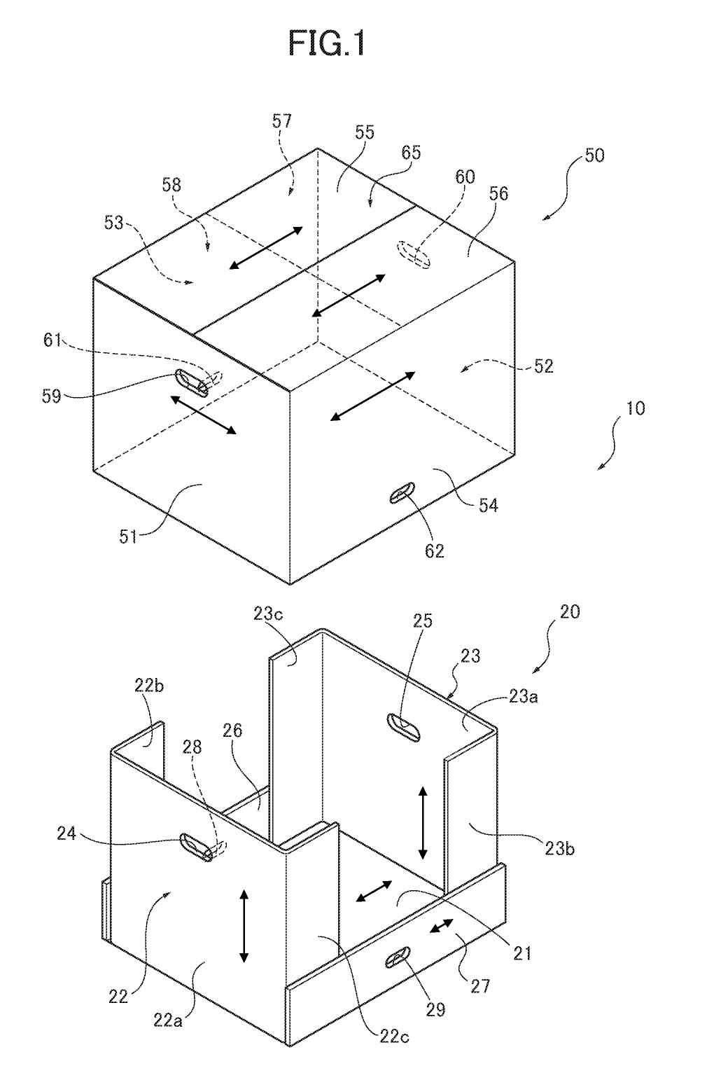

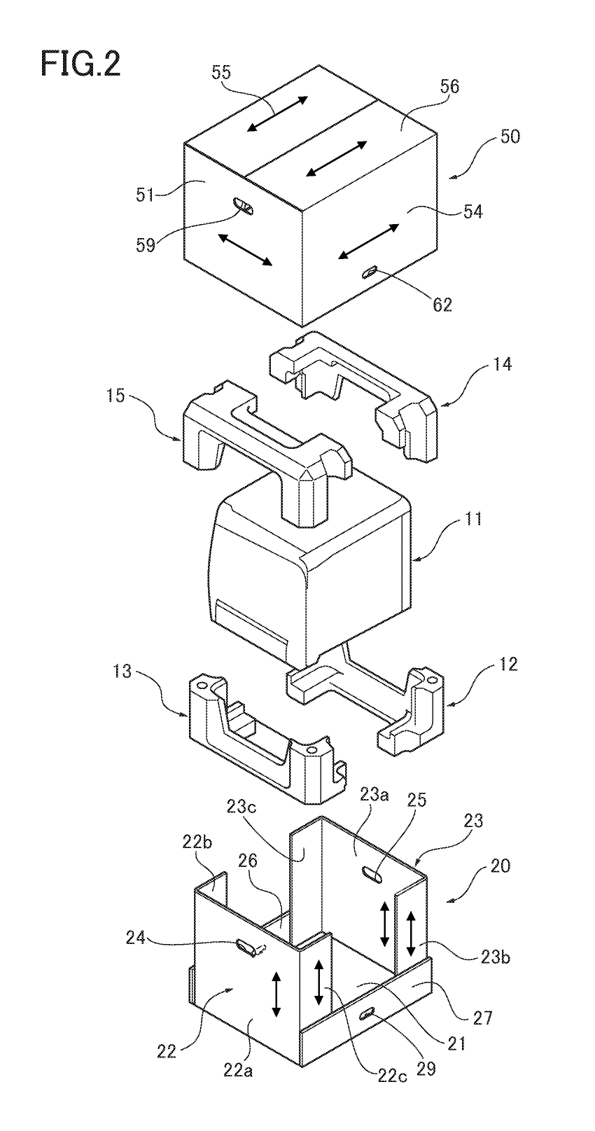

A packing unit according to a first embodiment is described with reference to FIG. 1 to FIG. 9. FIG. 1 is an exploded perspective view of a packing unit 10 and FIG. 2 is an exploded perspective view of the same for packing a product. The packing unit 10 in FIG. 1 comprises an inner case 20 and an outer case 50. To pack a product 11 in the packing unit 10, lower spacers 12, 13, the product 11, upper spacers 14, 15 are placed in this order on the inner case 20 and the outer case 50 is placed over the inner case 20.

Both of the inner and outer cases 20, 50 are made of cardboard. In the first embodiment the thickness of the cardboard of the outer case 50 is smaller than that of the inner case 20. For example, the cardboard of the inner case is an AB flute while that of the outer case 50 is a B flute. An AB flute is A flute and B flute bonded together. The number of flutes of the A flute per 30 cm is 34±2 and thickness is about 5.0 mm. That of the B flute is 50±2 and thickness is about 3.0 mm.

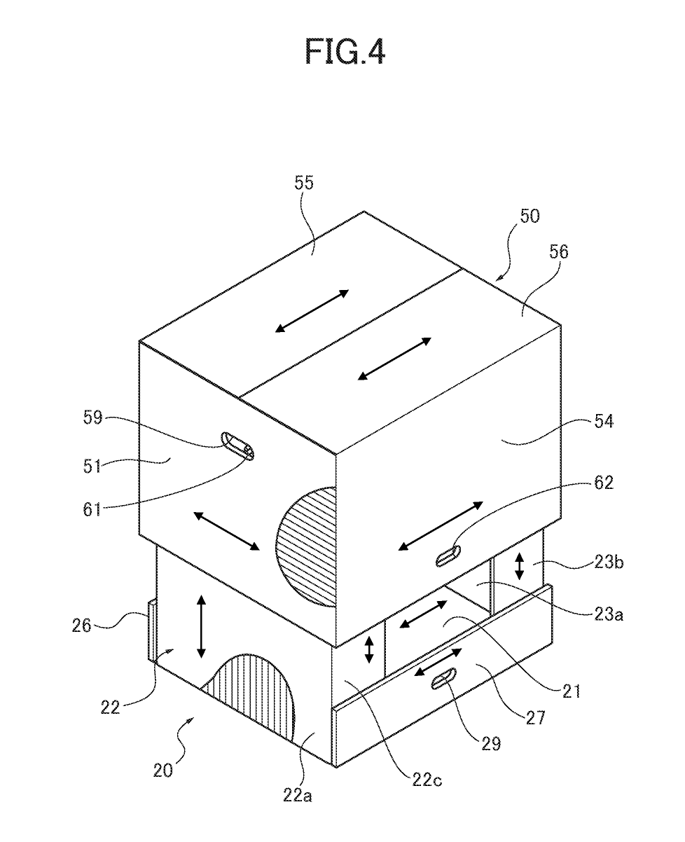

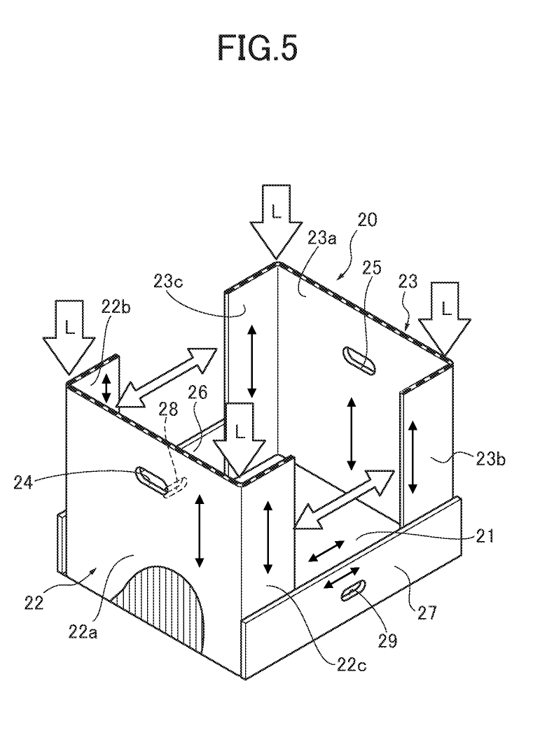

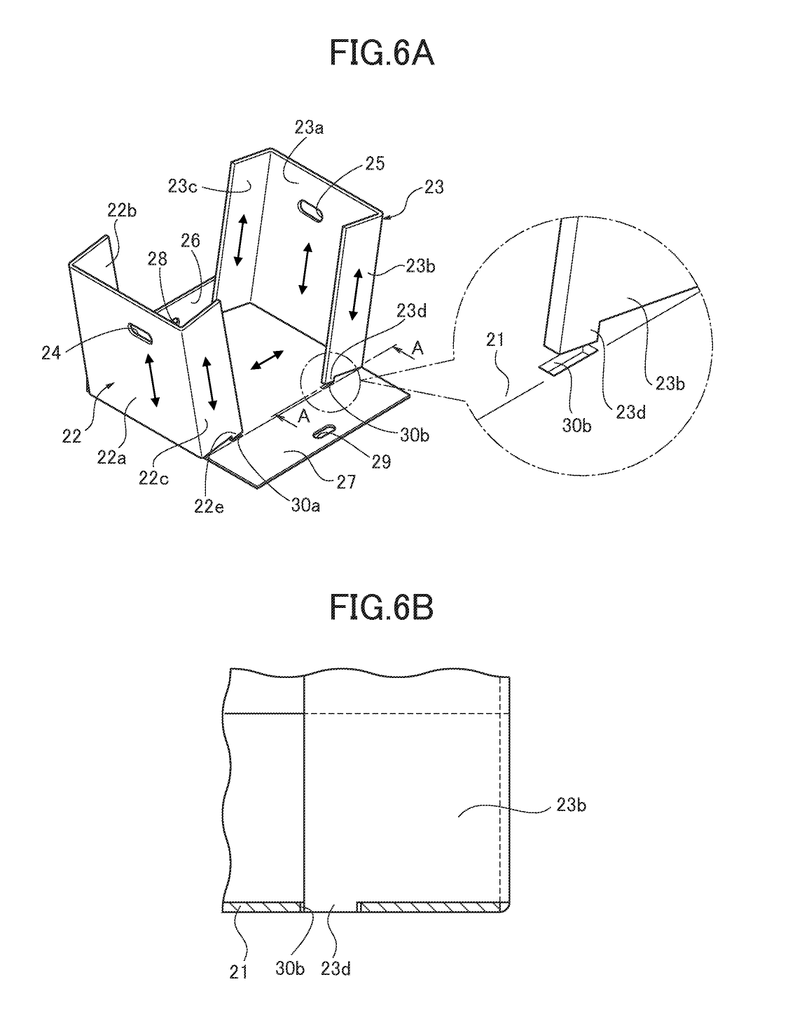

Next, the structures of the inner and outer cases 20, 50 are described. FIG. 2, 3A, 3B are development views of the inner case and outer case, respectively. FIG. 4 is a perspective view of an assembled packing unit 10 and FIG. 5 is a perspective view of the inner case of the packing unit. FIG. 6A perceptively shows the inner case with an enlarged perspective view of a part thereof showing a protrusion to fit into a slit while FIG. 6B is a cross section view of the same along the A to A line in FIG. 6A.

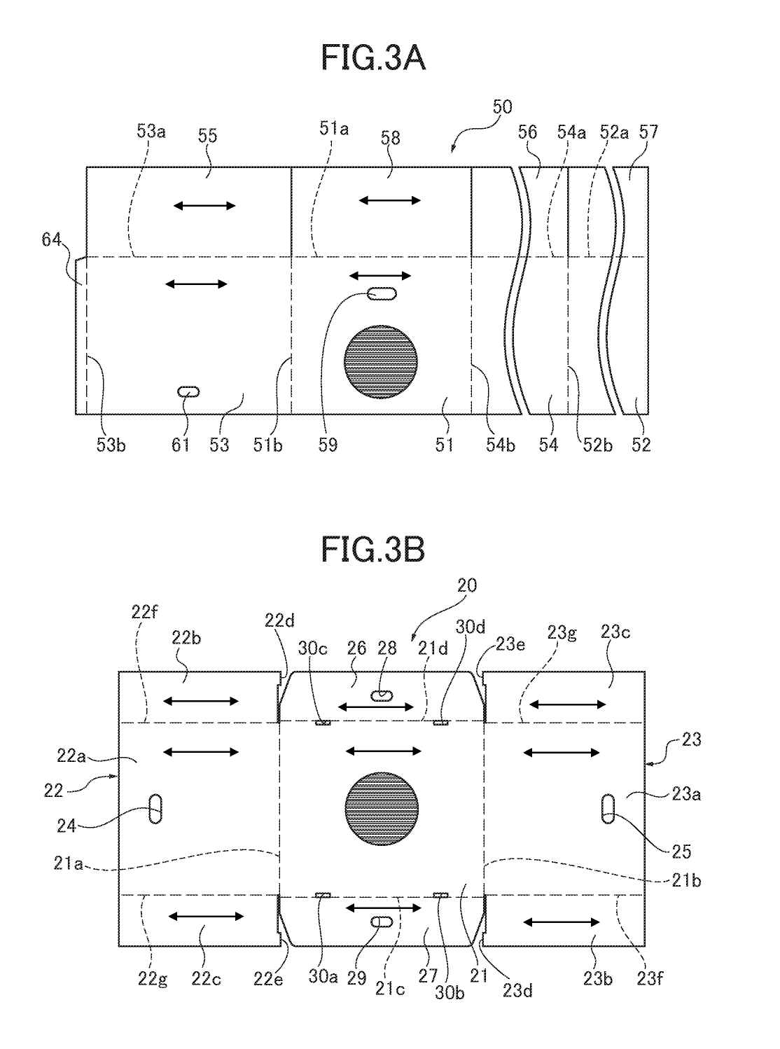

The inner case 20 is described first. In FIG. 3B the inner case 20 is formed of a single cardboard sheet of AB flute in a certain shape. The inner case 20 comprises a rectangular base panel 21, rectangular side panels 22, 23 to fold up from the base panel 21 and bottom flaps 26, 27. The base panel has two pairs of opposing sides 21a, 21b and 21c, 21d. The side panels 22, 23 are folded up along the sides 21a, 21b of the base panel as scores while the bottom flaps 26, 27 are in trapezoidal shape with the sides 21c, 21d as bases and folded up along the sides 21c, 21d as scores.

The inner case 20 is formed so that a flute direction or a long side of the flutes of the cardboard inner sheet of the side panel 23 is set to be vertical relative to a plane on which it is placed. In FIG. 1 to FIGS. 6A, 6B the flute direction is indicated by arrows and inner flutes are shown by cutting out a part of a surface liner in FIGS. 3A, 3B, 4, although the liner is not cut out actually.

The side panel 22 comprises a wall portion 22a adjacent to the side 21a of the base panel 21 and two side flaps 22b, 22c. The two side flaps 22b, 22c are vertical to the side 21a or adjacent to ends 22f, 22g of the wall portion 22a when vertically set up. The side flaps 22b, 22c are folded inside along the sides 22f, 22g as scores to align with the opposing sides 21c, 21d of the base panel 21.

Likewise, the side panel 23 comprises a wall portion 23a adjacent to the side 21b of the base panel 21 and two side flaps 23b, 23c. The two side flaps 23b, 23c are vertical to the side 21b or adjacent to ends 23f, 23g of the wall portion 23a when vertically set up. The side flaps 23b, 23c are folded inside along the sides 23f, 23g as scores to align with the opposing sides 21c, 21d of the base panel 21. Thus, the wall portions 22a, 23a and side flaps 22b, 22c, 23b, 23c of the side panels 22, 23 form corners. While piled up, a load from the above is applied primarily on the corners as indicated by the arrows L in FIG. 5. In the packing unit 10 the edges of the wall portions 22a, 23a and side flaps 22b, 22c, 23b, 23c (indicated by a broken line in FIG. 5) can bear a load so that the packing unit 10 excels in load bearing.

According to the first embodiment, when folded along the sides 21c, 21d, the side flaps 22b, 23c and side flaps 22c, 23b do not contact each other, as shown in FIG. 5. Thereby, the amount of cardboard sheet used for manufacturing the inner case 20 can be lowered, reducing its price without a decrease in load bearing capacity.

Further, the side flaps 22b, 22c, 23b, 23c include downward protrusions 22d, 22e, 23d, 23e at bottom edges, respectively, to maintain the folded positions on the sides 22f, 22g. The base panel 21 includes slits 30a, 30b, 30c, 30d along the sides 21c, 21d into which the protrusions 22d, 22e, 23d, 23e are inserted. By inserting the protrusions into the slits 30a, 30b, 30c, 30d, the side flaps 22b, 22c, 23b, 23c can be held at the folded positions. With the side flaps positioned stably, the product 11 can be easily placed and properly secured in the inner case 20. The slits 30a to 30b as depressions are formed along the long side of the flutes of the inner sheet of the base panel.

The wall portions 22a, 23a each include inner openings 24, 25 for an operator to grip to hold up the packing unit 10. Further, the bottom flaps 26, 27 each include inner holes 28, 29 through which a connector between the outer case 50 and inner case 20 is inserted.

Next, the outer case 50 is described. The outer case 50 in FIG. 3A is formed of a single cardboard sheet of B flute in a certain shape. As described above, because the side panels 22, 23 of the inner case 20 can bear a load from above, the cardboard of the outer case 50 can be reduced in thickness, so that the packing unit 10 can be provided at lower price. Also, the inner case 20 made of a single cardboard sheet can be manufactured at low yield owing to a simple shape, which can reduce the costs of parts and does not need to be secured with an adhesive or the like.

The outer case 50 comprises four side panels 51 to 54 and a rectangular top panel 65 to cover above the product 11. The top panel 65 is adjacent to top sides 51a to 54a of the side panels 51 to 54. The outer case 50 is assembled as follows. The side panels 51 to 54 are folded along their borders 51b, 52b, 54b as scores and joined at a margin 64 folded along an edge 53b to make a square. Then, top flaps 55 to 58 are folded down along scores 51a to 54a, overlapped and secured with an adhesive tape to form the top panel 65 as a lid.

According to the first embodiment the flute direction of the cardboard inner sheet of the side panels 51 to 54 is horizontal relative to the plane on which the packing unit 10 is placed. In FIG. 1 to FIGS. 6A, 6B the long side of the flutes is indicated by arrows and inner flutes are shown by cutting out a part of a surface liner of the outer case 50 in FIGS. 3A, 4, although the liner is not cut out actually.

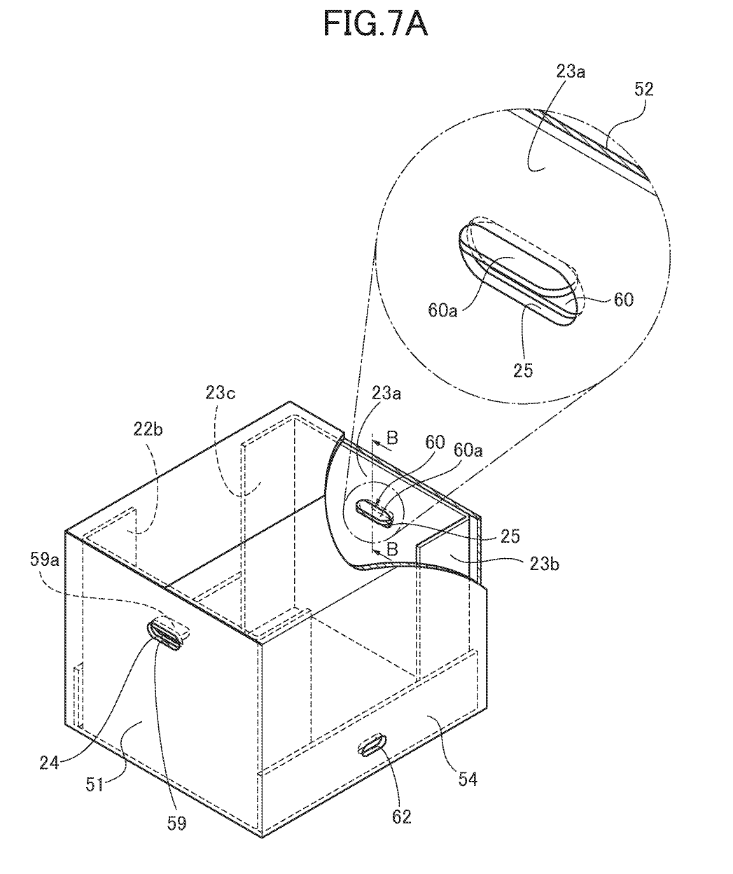

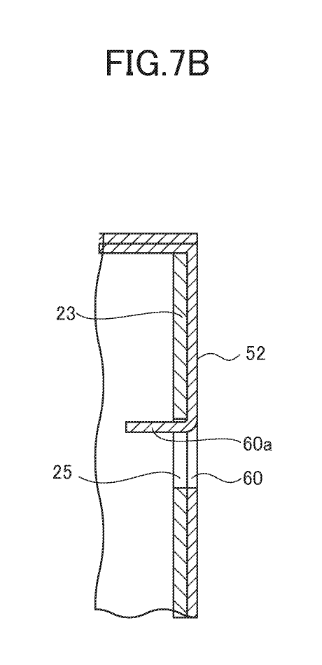

The outer case 50 also includes handhold openings 59, 60 for an operator to grip to hold up the packing unit 10. FIG. 7A is a partially cutout perspective view of the packing unit with a partially enlarged view of the opening. FIG. 7B is a cross section view of the same along the B to B line in FIG. 7A. The positions of the handhold openings 59 and 60 correspond to those of the inner openings 24, 25 of the inner case 20. The handhold openings 59, 60 have flaps 59a, 60a to fold inside along the upper edges. The handhold openings 59, 60 each include short sides vertical to the plane on which the packing unit is placed and long sides longer than the short sides and horizontal to the plane. The long sides of the handhold openings 59, 60 of the outer case 50 extend along the long side of the flutes of the inner sheet of the side panels of the outer case 50. As shown in FIG. 7A, the flap 60a of the handhold opening 60 is inserted into the inner opening 25 and the flap 59a of the handhold opening 59 is inserted into the inner opening 24. Accordingly, the inner case 20 is lifted together with the outer case 50 by an operator gripping the handhold openings 59, 60. The inner case 20 can be thus prevented from dropping.

Further, the side panels 53, 54 include outer holes 61, 62 through which a connector between the outer case 50 and inner case 20 is inserted. The positions of the outer holes correspond to those of the inner holes of the bottom flaps 26, 27 of the inner case 20. The inner case 20 and outer case 50 are joined via the connector inserting through the inner holes 28, 29 and outer holes 61, 62. The connector herein is a known element, for example, made from a synthetic resin to insert through the outer and inner holes, and be expanded inside by a manipulation from outside and secure the inner and outer cases 20, 50.

The inner case 20 and outer case 50 can be joined without the connector when the flaps of the handhold openings 59, 60 are properly pressed into the inner openings 24, 25. In this case the inner and outer holes 28, 29, 61, 62 are omissible.

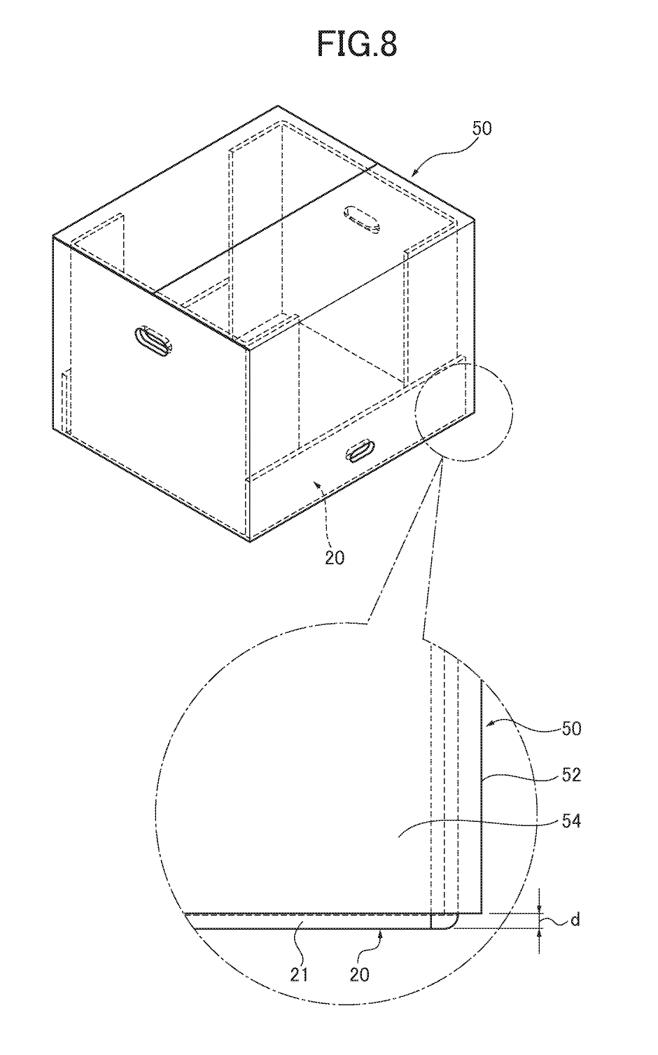

Next, the heights of the inner case 20 and outer case 50 are described. According to the first embodiment the height of the side panels 51 to 54 from the top panel 65 to the bottom is lower than that of the side panels 22, 23 of the inner case 20 from the base panel 21. FIG. 8 is a perspective view with a partially enlarged view, showing the heights of the inner and outer cases. As shown in the drawing, when the packing unit 10 is placed on a plane, a gap d is formed between the side panels 51 to 54 and the plane. The side panels 51 to 54 can be prevented from touching the plane and being deformed even when the packing units 10 are piled up and compressed.

Further, the packing unit 10 according to the first embodiment is configured that the inner case 20 bears a load from above. Because of this, even with the occurrence of a distortion in the inner case 20 when stored over a long time, the bottom edge of the outer case 50 can be avoided from contacting the upper surface of a transport pallet or another packing unit below, which can prevent or reduce a body swelling.

Next, how to pack the product 11 in the inner and outer cases 20, 50 are described. First, the inner case 20 is developed as shown in FIG. 3B, then, the product 11 is set on the lower spacers 12, 13 attached on the base panel 21 and the upper spacers 14, 15 are set on the product 11. Next, the wall portions 22a, 23a are folded up along the sides 21a, 21b as scores. The side flaps 22b, 22c and 23b, 23c are folded in along the sides 22f, 21g and 23f, 23g, respectively, to align with the sides 21c, 21d and the protrusions 22d, 22e, 23d, 23e are inserted into the slits 30a, 30b, 30c, 30d. Thereby, the side flaps 22b, 22c, 23b, 23c are tentatively secured around the base panel 21. Then, the bottom flaps 26, 27 are folded up along the sides 21c, 21d.

Next, the pre-assembled outer case 50 is placed over the inner case and the connectors 28, 29 are fitted into the outer holes 61, 62 to join the two cases.

For manually moving the packing unit 10 by an operator, the operator bends the flaps 59a, 60a into the inner openings 24, 25 and grips the flaps with his or her fingers.

Further, according to the first embodiment the packing unit 10 can be prevented from being deformed even while a number of packing units 10 are piled up on a pallet and the side surfaces are covered with a stretch film. The outer case 50 is placed on the plane so that the long side of the flute becomes horizontal to the plane. Because of this, the packing unit exerts high strength against compression and the occurrence of creases or crinkles in the vertical edge lines or breakage can be prevented.

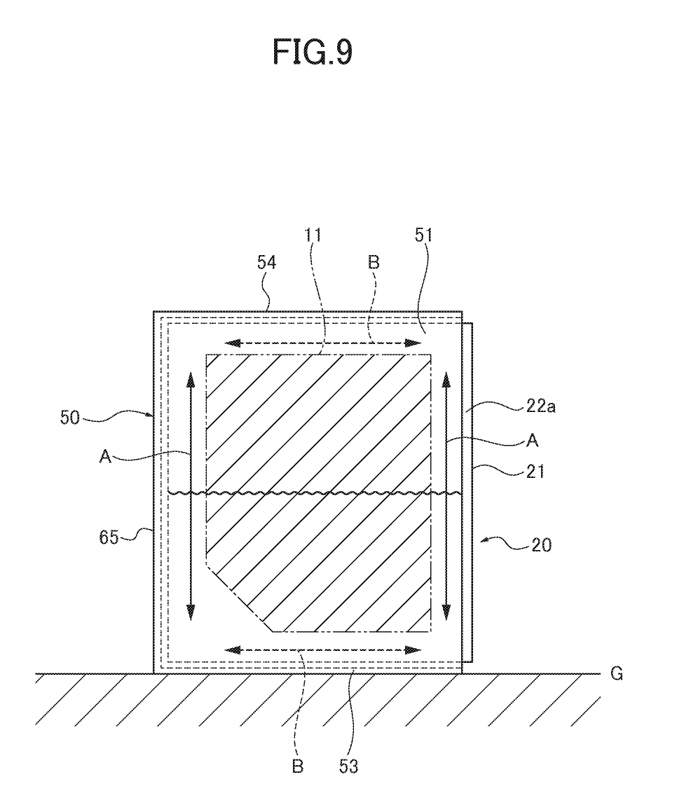

Further, the packing unit 10 can exert a certain level of strength even when piled up laterally. Laydown or lateral disposition of packing units is generally prohibited but in reality packing units may be laid down due to a limitation to an installation site or a storage. FIG. 9 shows the packing unit when laid down. If the side panel 51 of the outer case 50 is located below and the side panel 52 is located above, the long sides of the flutes of the side panels 22, 23 thereof are horizontal to the plane G as indicated by the arrow B in FIG. 9. Therefore, the inner case 20 alone cannot exert load bearing property.

However, according to the outer case 50 the long sides of the flutes of the side panels 51, 52 are vertical relative to the plane G, therefore, the outer case 502 exerts load bearing property. Even with any of the side panels 52 to 54 positioned at bottom, another side panel vertical to the plane G can bear a load. For this purpose, the inner case 20 and outer case 50 have to be accurately created in dimension without a gap between them.

### Second Embodiment

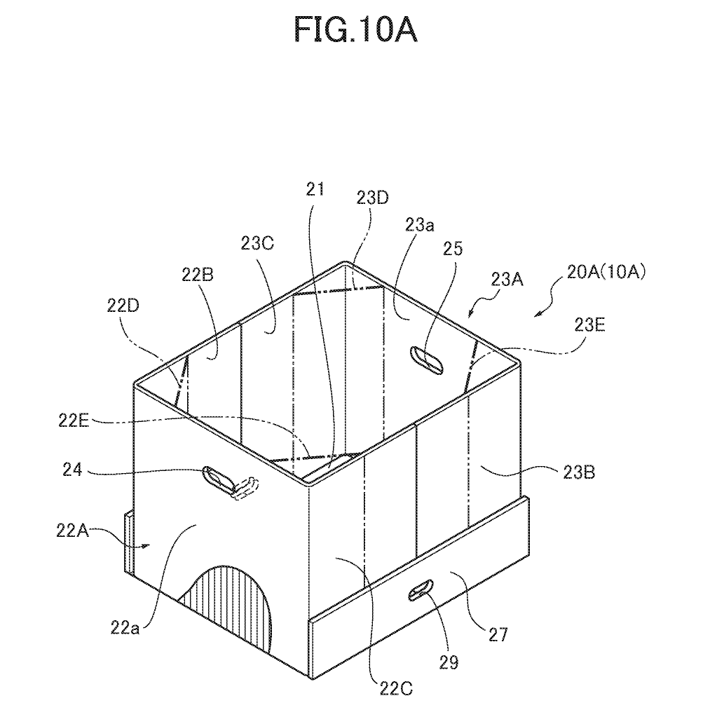

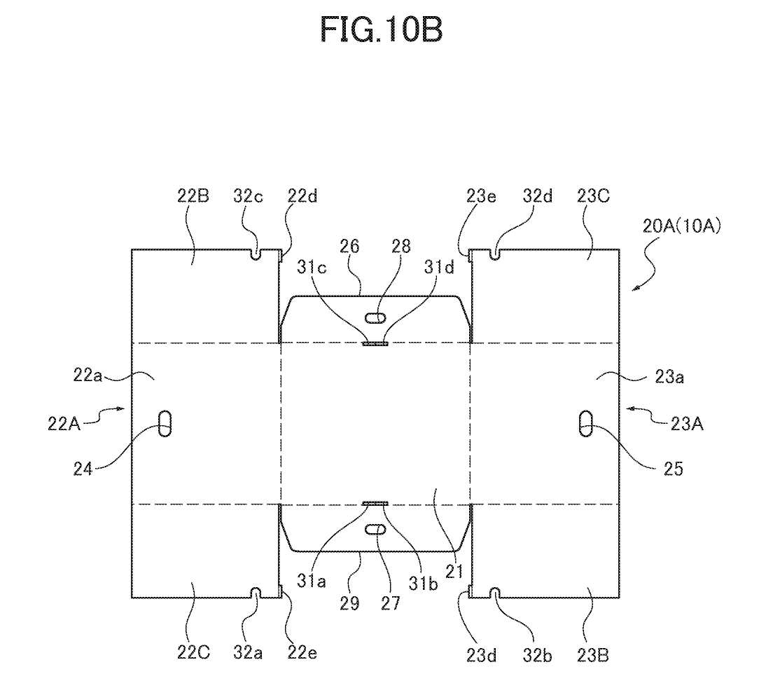

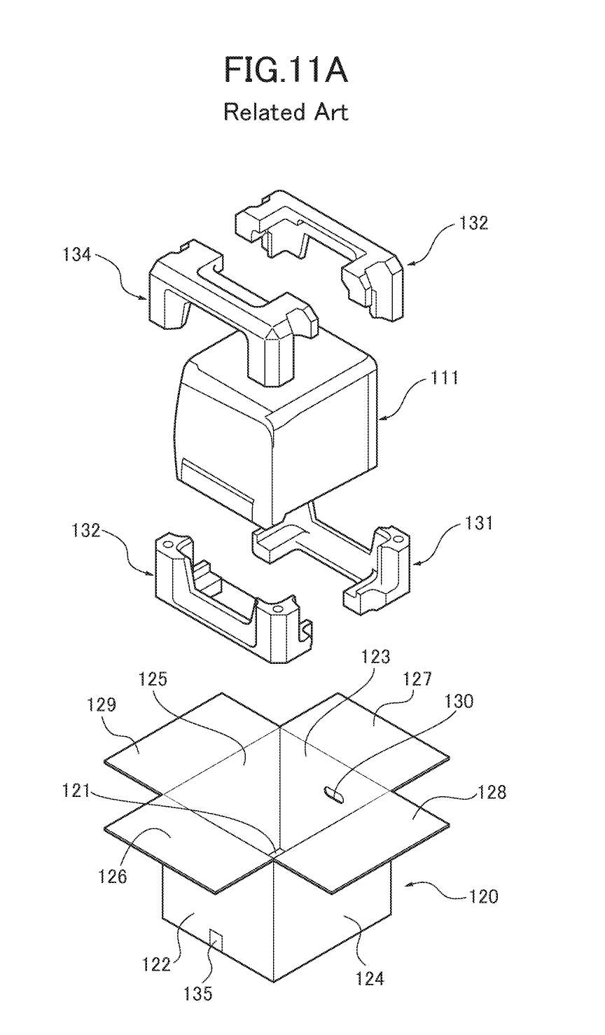

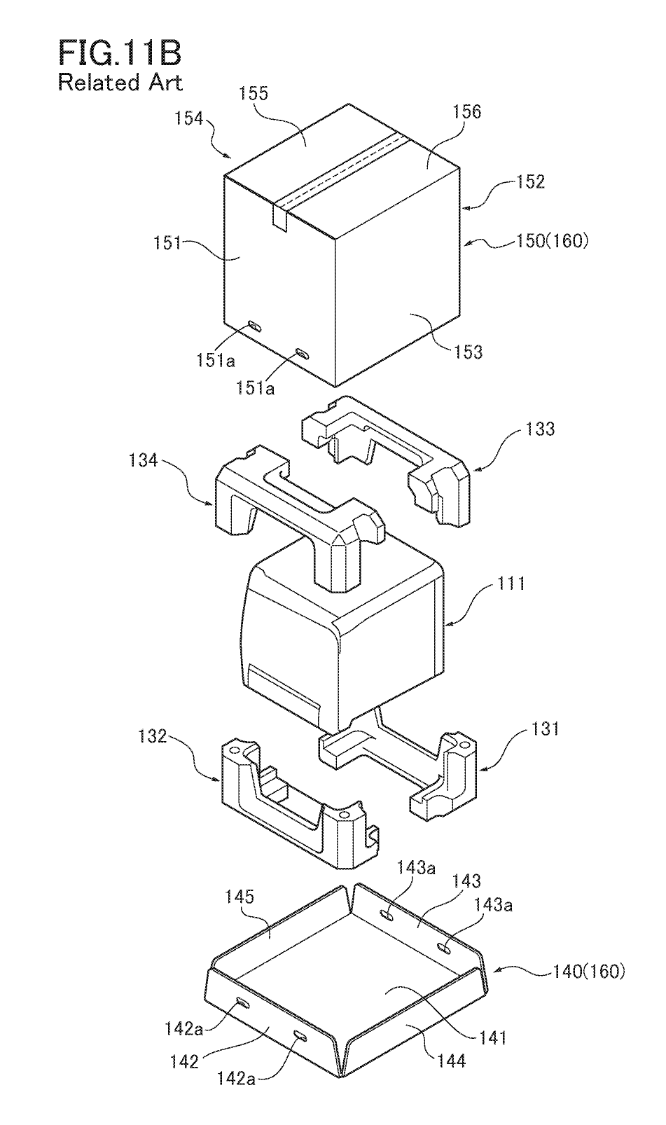

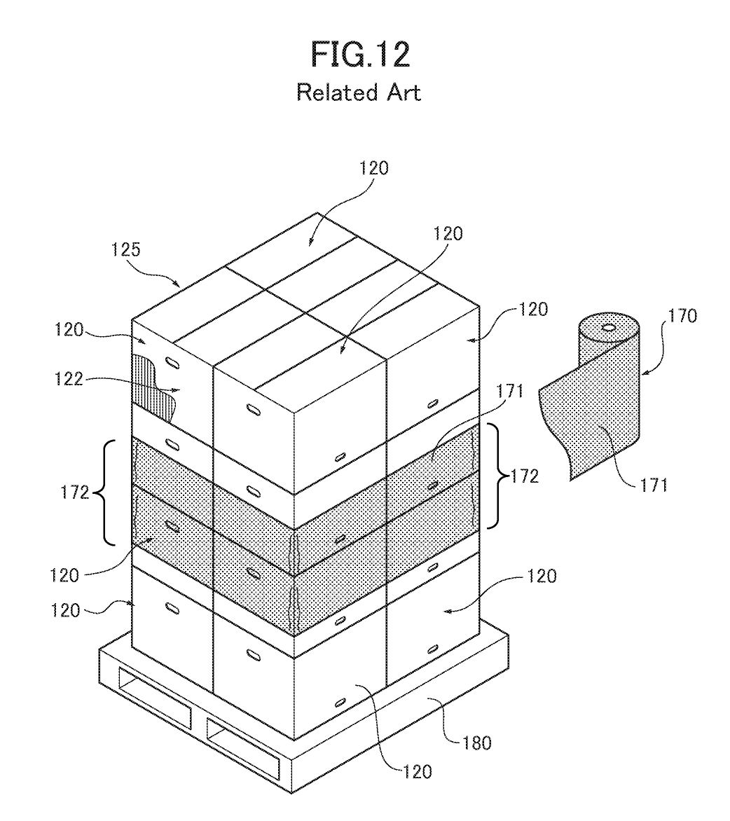

Next, a packing unit according to a second embodiment is described referring to FIGS. 10A, 10B. FIGS. 10A, 10B are a perspective view and a development view of an inner case 20A of a packing unit 10A. In the second embodiment side flaps 22B, 22C, 23B, 23C of the opposing side panels 22, 23 of the inner case 20A are formed to be longer than those in the first embodiment. Thus, their edges contact each other when folded up along the sides 21c, 21d of the base panel 21. As shown in FIG. 10B, protrusions 22d, 22e, 23d, 23e are formed at bottom ends of the side flaps 22B, 22C, 23B, 23C, respectively. Slits 31a, 31b, 31c, 31d are also provided corresponding to the protrusions 22d, 22e, 23d, 23e in the base panel 21. Further, notches 32a, 32b, 32c, 32d are provided in the side flaps 22B, 22C, 23B, 23C so as not to block the inner holes 28, 29.

The packing unit 10A excels in load bearing property because the side flaps 22B, 22C and the side flaps 23B, 23C contact each other and the length thereof along the sides 21c, 21d is larger. Moreover, the side flaps 22B, 22C, 23B, 23C of the inner case 20A form continuous longitudinal walls, which form a double-layered structure together with the side panels 53, 54 of the outer case 50. Therefore, it can have a sufficient strength as a whole even if it is laid down. The packing unit 10A is very useful and effective in a case where a means of transportation is indefinite or it is to be transported in an area in which rough load handling is expected.

In the inner case 20A the elongated side flaps 22B, 22C, 23B, 23C can be folded inside halfway, as shown in FIG. 10A, to form corner walls 22D, 22E, 23D, 23E. Thus, the inner case 20A can include vertical hollows with a triangular cross section at from top to bottom of the four corners so that its load bearing capacity can be further improved.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. A packing unit comprising:
an inner case made of cardboard to contain a good on an upper side, including a base panel having two pairs of opposing sides and two side panels to be folded up along a first one of the two pairs of opposing sides as scores; and
an outer case made of cardboard in a square shape with a lid to be placed over the inner case, including a top panel to cover above the good and four side panels to cover side faces of the inner case, wherein:
the cardboard of the side panels of the inner case includes an inner sheet with a flute having a long side in a vertical direction relative to a plane on which the packing unit is placed; and
the cardboard of the side panels of the outer case includes an inner sheet with a flute having a long side in a horizontal direction relative to the plane on which the packing unit is placed.

2. The packing unit according to claim 1, wherein:
each of the side panels of the inner case comprises a wall portion to be folded up along the first pair of opposing sides of the base panel and two side flaps to be folded along both vertical ends of the wall portion when folded as scores and extend along a second pair of opposing sides of the base panel; and
the two side flaps extending along the second pair of opposing sides do not contact each other.

3. The packing unit according to claim 2, wherein:
each of the side flaps when folded includes a downward protrusion at a bottom end; and
the base panel of the inner case includes depressions to accommodate the protrusions of the side flaps.

4. The packing unit according to claim 3, wherein the depressions are formed along the long side of the flute of the inner sheet of the base panel.

5. The packing unit according to claim 3, further comprising handhold openings in the wall portions of the inner case and the side panels of the outer case corresponding to the wall portions at a same position when assembled, with which the inner case and outer case are raised concurrently.

6. The packing unit according to claim 5, wherein
the handhold openings each include short sides vertical to the plane on which the packing unit is placed and long sides longer than the short sides and horizontal to the plane; and
the long sides of the handhold openings of the outer case extend along the long side of the flute of the inner sheet of the side panels of the outer case.

7. The packing unit according to claim 1, wherein:
each of the side panels of the inner case comprises a wall portion to be folded up along the first pair of opposing sides of the base panel and two side flaps to be folded along both vertical ends of the wall portion when folded as scores and extend along the second pair of opposing sides of the base panel; and
the two side flaps extending along the second pair of opposing sides contact each other at ends.

8. The packing unit according to claim 1, wherein
a height of the side panels of the outer case is smaller than that of the wall portions of the inner case.

9. The packing unit according to claim 1, wherein
a thickness of the cardboard of the outer case is smaller than that of the cardboard of the inner case.

10. The packing unit according to claim 1, wherein:
the outer case is made of a single cardboard sheet;
the four side panels are continuously formed along the long side of the flute of the inner sheet; and
the top panel is formed from top sides of the four side panels to a short side of the flute of the inner sheet.

11. A method of assembling a packing unit comprising an inner case and an outer case each made of a cardboard sheet, comprising:
to form the inner case, folding up two side panels along a first pair of opposing sides of a base panel so that a long side of a flute of the cardboard sheet of the side panels is set in a vertical direction relative to a plane on which the packing unit is placed, folding in two side flaps to extend along a second pair of opposing sides, and folding up bottom flaps along the second pair of opposing sides;
to form the outer case, folding four side panels along borders so that a long side of a flute of the cardboard sheet of the side panels is set in a horizontal direction relative to the plane on which the packing unit is placed, and joining the side panels at a margin with an adhesive;
folding down top flaps along top sides of the side panels and joining the top flaps with an adhesive tape; and
placing the outer case over the inner case.
